(19) United States
(12) Patent Application Publication
(10) Pub. No.: US 2026/0336495 A1
(43) Pub. Date: Oct. 29, 2026

(54) VEHICLE SEATING ASSEMBLY HAVING SLIDING CALF SUPPORT MECHANISM

(71) Applicant: Ford Global Technologies, LLC, Dearborn, MI (US)

(72) Inventors: Ranjit Nagi, Saline, MI (US); Chris Fredriksson, LaSalle (CA); Jimmy Moua, Superior Township, MI (US); Emmanuelle Correa Conde, Mexico City (MX); Patrick Maloney, Livonia, MI (US); Julia Fox, Novi, MI (US); Todd A. Gagnier, Livonia, MI (US); Johnathan Andrew Line, Northville, MI (US)

(73) Assignee: Ford Global Technologies, LLC, Dearborn, MI (US)

(21) Appl. No.: 19/191,462

(22) Filed: Apr. 28, 2025

(51) Int. Cl. B60N 2/90

(52) U.S. Cl. CPC B60N 2/995

(57) ABSTRACT

A vehicle seating assembly comprises a support bracket and a calf support mechanism. The calf support mechanism comprises a link assembly, a dual-link assembly, a calf rest coupled to the dual-link assembly, and a guide member. The guide member is coupled to the first link assembly and the dual-link assembly. The calf support mechanism is configured to simultaneously extend the calf rest and pivot the calf rest between a retracted position, an intermediate position, and an extended position.

### FIELD OF THE DISCLOSURE

The present disclosure generally relates to a sliding calf support mechanism for a vehicle seating assembly.

### BACKGROUND OF THE DISCLOSURE

Vehicle seating assemblies may include mechanisms to support the legs of a user of the vehicle. Such mechanisms may extend from the vehicle seating assembly, supporting the calves of the user to provide comfort and stability to the user while the vehicle is stationary and not moving. It would be desirable to provide a vehicle seat with a support mechanism to accommodate a diverse array of users, while maintaining a seamless appearance with the rest of the vehicle seating assembly.

### SUMMARY OF THE DISCLOSURE

According to a first aspect of the present disclosure, a vehicle seating assembly comprises a support bracket and a calf support mechanism. The calf support mechanism comprises a link assembly operatively coupled with the support bracket, a dual-link assembly, a calf rest coupled to the dual-link assembly, and a guide member, wherein the guide member is coupled to the link assembly and the dual-link assembly to guide the calf rest of the calf support mechanism between a retracted position and an extended position.

Embodiments of the first aspect of the present disclosure can include any one or a combination of the following features:
the link assembly may include a slide link and a guide link, wherein the slide link is slidably coupled with the guide link.
the dual-link assembly may include a pair of slide links and a dual guide link, wherein the pair of slide links are slidably coupled to opposed sides of the dual guide link.
the slide link may be coupled to the guide member.
the pair of slide links of the dual guide link each comprise an outer slide link and an inner slide link, wherein the inner slide link is coupled with the calf rest.
the calf rest may comprise a base member, an intermediary member slidably coupled to the base member, and an end member slidably coupled to the intermediary member.
the dual-link assembly may be coupled to the end member of the calf rest.

According to a second aspect of the present disclosure, a vehicle seating assembly comprises a seatback frame, a support bracket, and a calf support mechanism that comprises a hinge member, a calf rest pivotably coupled to the hinge member, a first link assembly operatively coupled to the support bracket, a second link assembly operatively coupled to the support bracket, a first dual-link assembly operatively coupled to the calf rest, a second dual-link assembly operatively coupled to the calf rest, and a first guide member wherein the first guide member is coupled to the first link assembly and the first dual-link assembly to guide the calf rest between a retracted position and an extended position.

Embodiments of the second aspect of the present disclosure can include any one or a combination of the following features:
a crossbar that may extend between the first link assembly and the second link assembly.
a cross-link that may extend between the first dual-link assembly and the second dual-link assembly.
a connector plate that may extend between the first link assembly and the second link assembly.
the connector plate may comprise a first overhang positioned adjacent to the first link assembly and a second overhang positioned adjacent to the second link assembly.
the connector plate may provide a first guiding slot formed by the first overhang and a second guiding slot formed by the second overhang.
the first guide member may form a first guiding shaft slidably coupled with the first guiding slot.
a first length of the first guiding slot may be vertically superior relative to a second length of the first guiding slot.

According to a third aspect of the present disclosure, a vehicle seating assembly comprises a seatback frame, a support bracket, and a calf support mechanism operable between a first position and a second position, comprising a hinge member coupled to the support bracket; a calf rest pivotably coupled to the hinge member; a first link assembly operatively coupled to the support bracket, a second link assembly operatively coupled to the support bracket, a first dual-link assembly operatively coupled to the calf rest, a second dual-link assembly operatively coupled to the calf rest, a first guide member, wherein the first guide member is pivotably coupled to the first link assembly and the first dual-link assembly to guide the calf rest between the retracted position and the extended position, a second guide member, wherein the second guide member is pivotably coupled to the second link assembly and the second dual-link assembly to guide the calf rest between the retracted position and the extended position, and an expandable trim member coupled to the calf rest.

Embodiments of the third aspect of the present disclosure can include any one or a combination of the following features:
the calf rest may comprise a base member pivotably coupled to the hinge member, an intermediary member slidably coupled to the base member, and an end member slidably coupled to the intermediary member.
the expandable trim member may extend between the base member and the end member to substantially cover an exterior surface of the calf rest.
the intermediary member may be configured to slide relative to the base member and the end member may be configured to slide relative to the intermediary member as the calf support mechanism transitions between the first position and the second position.
the expandable trim member may be configured to elastically expand as the calf support mechanism transitions from the first position to the second position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a vehicle seating assembly with an extended calf rest and positioned within a vehicle.

FIG. 2A is a top perspective view of a support bracket of the vehicle seating assembly coupled with a calf support mechanism in a retracted position.

FIG. 2B is a top perspective view of a support bracket of the vehicle seating assembly coupled with a calf support mechanism in an intermediate position.

FIG. 2C is a top perspective view of a support bracket of the vehicle seating assembly coupled with a calf support mechanism in an extended position.

FIG. 3 is a top perspective exploded view of the support bracket of the vehicle seating assembly and the calf support mechanism.

FIG. 4 is a cross-sectional view of the calf support mechanism taken at lines IV in FIG. 2A.

FIG. 5 is a top perspective view of a hinge plate of the calf support mechanism.

FIG. 6A is a partial cross-sectional view taken at lines VIA in FIG. 2C of a calf rest of the calf support mechanism in the extended position.

FIG. 6B is a partial cross-sectional view taken at lines VIB in FIG. 2B of the calf rest of the calf support mechanism in the intermediate position.

FIG. 6C is a partial cross-sectional view taken at lines VIC in FIG. 2A of the calf rest of the the calf support mechanism in the retracted position.

FIG. 7 is a top perspective view of a connector plate of the calf support mechanism.

FIG. 8 is a bottom perspective view of the connector plate of the calf support mechanism.

FIG. 9 is a bottom perspective view of the connector plate of the calf support mechanism showing a first side plate and the second side plate coupled with the connector plate.

FIG. 10 is a bottom perspective view of the connector plate of the calf support mechanism showing a first link assembly and a second link assembly coupled with the connector plate.

FIG. 11 is a top perspective view of the first link assembly and the second link assembly.

FIG. 12 is a bottom perspective view of the connector plate showing a crossbar, a calf support actuator, an actuating element, a first guide member, and a second guide member coupled with the connector plate.

FIG. 13 is a top perspective view of the crossbar.

FIG. 14 is a top perspective view of the calf support mechanism.

FIG. 15 is a bottom perspective view of the calf support mechanism.

FIG. 16 is a bottom perspective view of the calf support mechanism showing a first dual-link assembly and a second dual-link assembly coupled with the calf rest.

FIG. 17 is a bottom perspective view of the link assemblies, the dual-link assemblies, and the guiding members of the calf support mechanism.

FIG. 18 is a side perspective view of the calf support mechanism, showing an expandable trim member of the calf support mechanism.

FIG. 19A is a bottom perspective view of the link assemblies, dual-link assemblies, guide members, and the calf rest in the retracted position.

FIG. 19B is a bottom perspective view of the link assemblies, dual-link assemblies, guide members, and the calf rest in the intermediate position.

FIG. 19C is a bottom perspective view of the link assemblies, dual-link assemblies, guide members, and the calf rest in the extended position.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

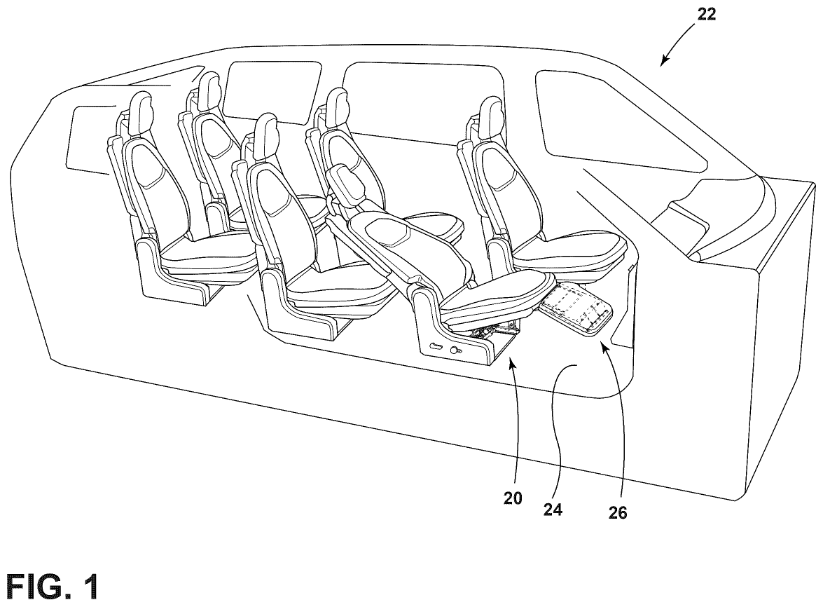

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle seating assembly having a calf support mechanism, specifically, a sliding calf support mechanism. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-19C, reference numeral 20 generally designates a vehicle seating assembly 20 for a vehicle 22. The vehicle seating assembly 20 is coupled to a floor 24 of the vehicle 22 and is configured to support a user accommodation 26 adapted to receive a user of the vehicle 22. The vehicle seating assembly 20 includes a support bracket 28, a frame operatively coupled to the support bracket 28, and a calf support mechanism 32. The calf support mechanism 32 is operably attached to a front portion 34 of the support bracket 28. The calf support mechanism 32 is operable by a user of the vehicle seating assembly 20 to laterally extend and to raise a calf rest 36 relative to the support bracket 28, such that the legs of the user are supported by the calf rest 36 and positioned off the floor 24 of the vehicle 22.

Referring to FIG. 1, the vehicle seating assembly 20 may be positioned within the vehicle 22. For example, the vehicle seating assembly 20 may be positioned within a passenger compartment of the vehicle 22. The vehicle 22 may be a motor vehicle. For example, the vehicle 22 may be a land-based vehicle (e.g., an automobile, a motorcycle, a train, etc.), or an air-based vehicle (e.g., a plane or other aircraft). While the vehicle 22 may be a motor vehicle, the present disclosure is not limited to internal combustion engines as a source of locomotive power to the vehicle 22. For example, locomotive power may be provided to the vehicle 22 by electric motors, fuel cells, and/or petroleum-based fuel engines. According to various examples, a semi-autonomous example of the vehicle 22 may perform many, or all, commuting functions (e.g., braking, turning, signaling, etc.) independent of user interaction while the user maintains override control of the vehicle 22.

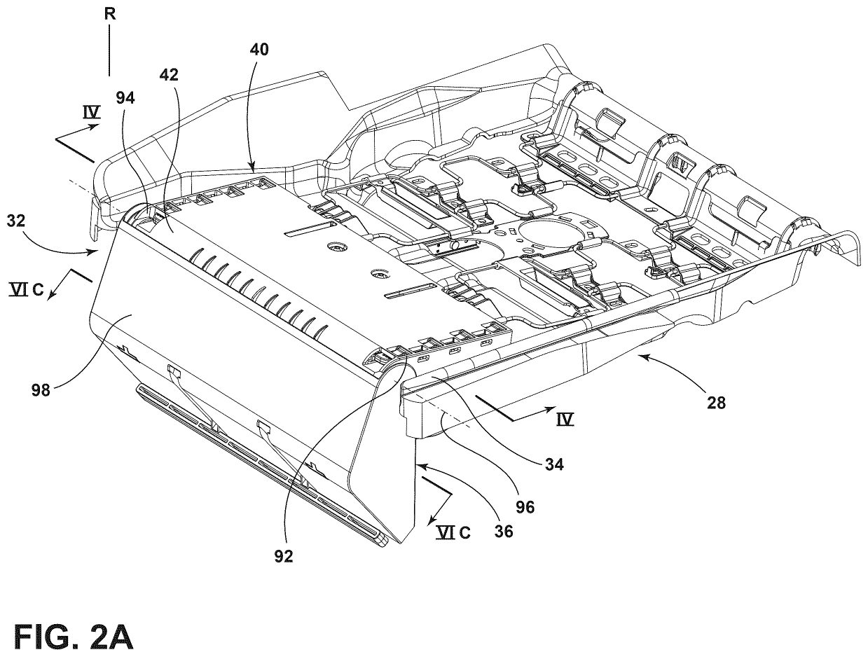

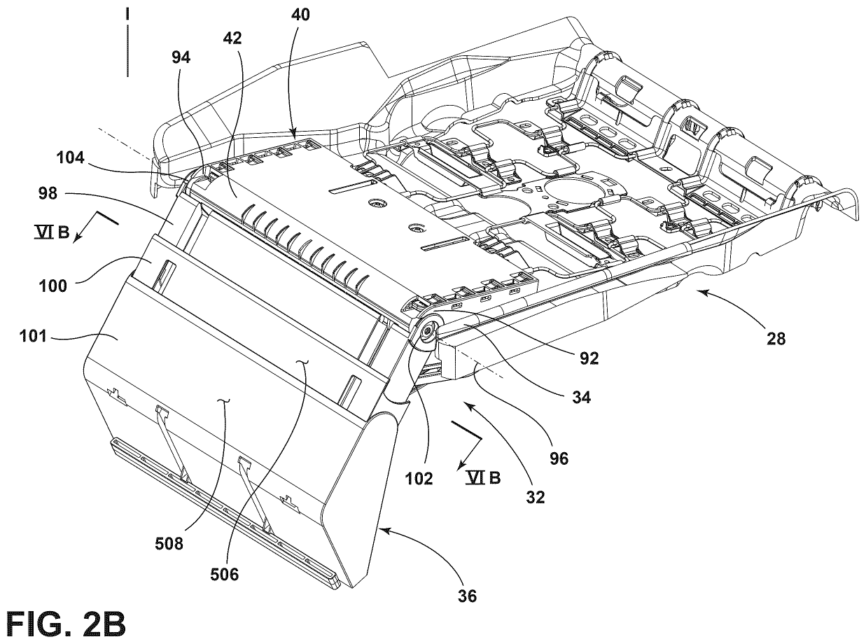

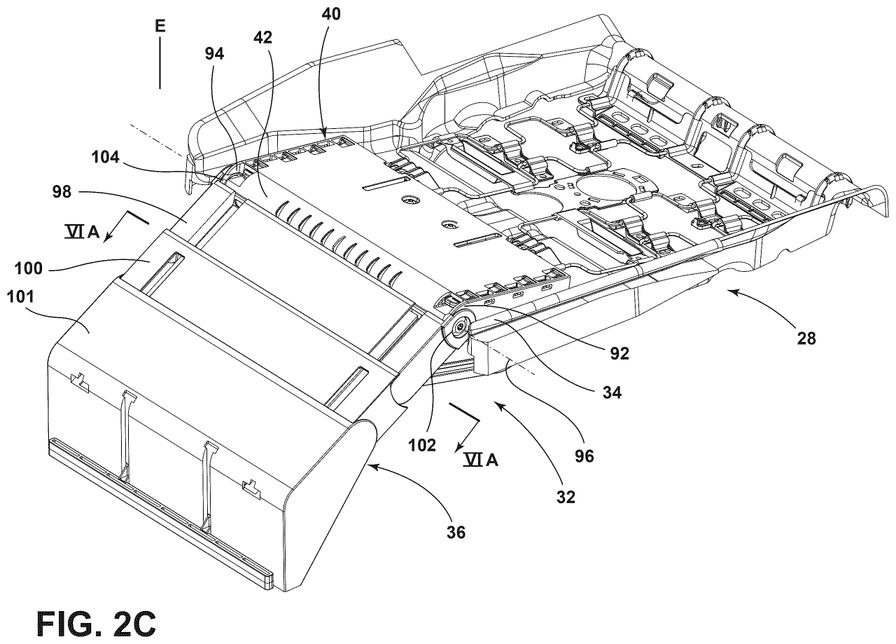

Referring to FIG. 2A-2C, the calf support mechanism 32 is attached to the front portion 34 of the support bracket 28 and is operable by a user to extend a calf rest 36 from at least a first position to a second position. Specifically, the calf support mechanism 32 is operable by a user to extend the calf rest 36 between a retracted position R, an intermediate position I, and an extended position E while the vehicle is stationary and not moving. The support bracket 28 is coupled to a seat component such as the seatback frame. The calf support mechanism 32 is shown in the retracted position R in FIG. 2A. In the retracted position R, the calf rest 36 is positioned proximal to the support bracket 28, and vertically extends substantially perpendicular to the support bracket 28. The calf support mechanism 32 is shown in the intermediate position I in FIG. 2B. In the intermediate position I, the calf rest 36 is partially extended laterally from the support bracket 28 and partially lifted vertically relative to the floor 24 of the vehicle 22. The calf support mechanism 32 is shown in the extended position E in FIG. 2C. In the extended position E, the calf rest 36 is fully extended laterally from the support bracket 28 and fully lifted vertically relative to the floor 24 of the vehicle 22. As such, as the calf support mechanism 32 transitions from the retracted R, to the intermediate I, and to the extended position E, the calf rest 36 is both laterally expanded from the support bracket 28 and is lifted vertically relative to the floor 24 of the vehicle 22.

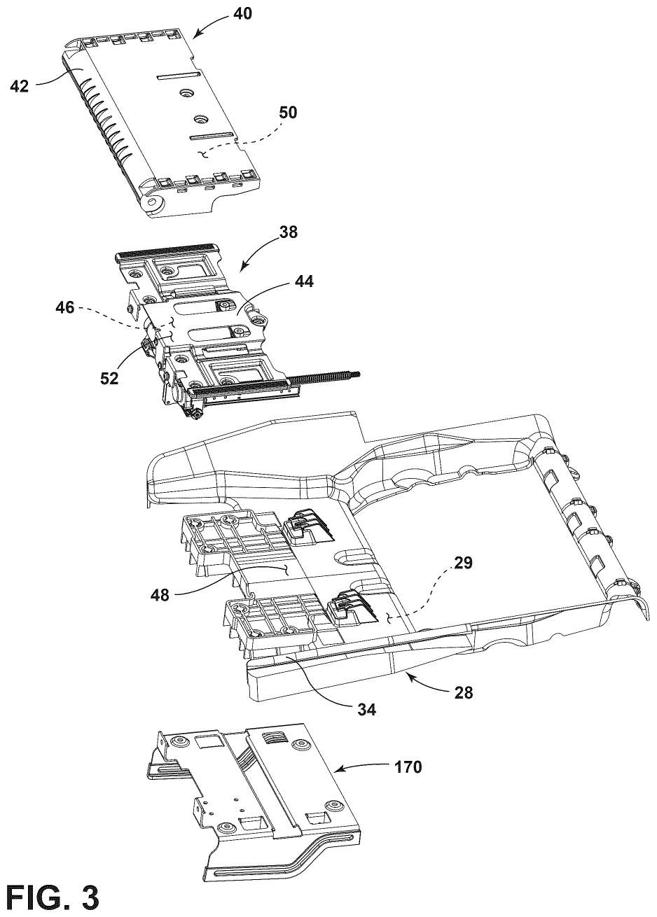

With reference now to FIG. 3, the calf support mechanism 32 includes an attachment plate 38, a hinge plate 40, the calf rest 36, and a pivot member 42.

The hinge plate 40 is positioned at the front portion 34 of the support bracket 28, proximal to the front of the vehicle 22. Specifically, an inner surface 50 of the hinge plate 40 is interfaced with and coupled to an exterior surface 52 of the attachment plate 38. Accordingly, the hinge plate 40 is coupled to the support bracket 28 via the attachment plate 38. The inner surface 50 of the hinge plate 40 may be coupled with the attachment plate 38 via bolts, welds, or other various fasteners. Alternatively, the hinge plate 40 may be integrally formed with the support bracket 28.

The attachment plate 38 generally forms a planar body 44 configured to support one or more actuators coupled with an inner surface 46 of the attachment plate 38. The attachment plate 38 is coupled to and positioned at the front portion 34 of the support bracket 28. Specifically, portions of the inner surface 46 of the attachment plate 38 are interfaced with and coupled to an exterior surface 48 of the support bracket 28. The portions of the inner surface 46 of the attachment plate 38 coupled with the support bracket 28 may be fixed to the support bracket 28 via bolts, a weld, or other various fasteners. Alternatively, the attachment plate 38 may be integrally formed with the support bracket 28.

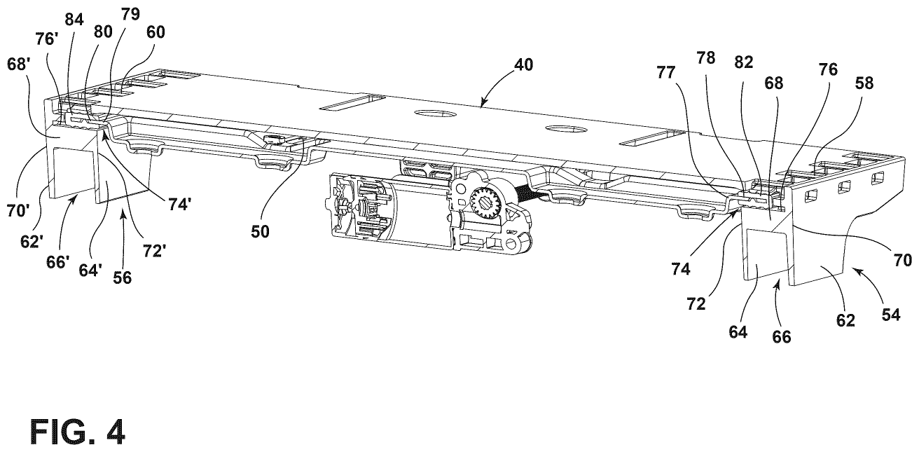

Referring now to FIG. 4, the hinge plate 40 forms a first vertical protrusion 54 and a second vertical protrusion 56. The first vertical protrusion 54 vertically extends towards the floor 24 of the vehicle 22 from a first side 58 of the hinge plate 40. Likewise, the second vertical protrusion 56 vertically extends towards the floor 24 of the vehicle 22 from a second side 60 of the hinge plate 40. Further, both the first and second vertical protrusions 54, 56 laterally extend at least a portion of the length of the hinge plate 40.

With continued reference to FIG. 4, each of the vertical protrusions 54, 56 are formed of an outer wall 62, 62′ and an inner wall 64, 64′ that are laterally spaced from one another to define a protrusion gap 66, 66′ therebetween. A cross member 68, 68′ laterally extends between a top portion 70,70′ of both the outer wall 62, 62′ and a top portion 72, 72′ of the inner wall 64, 64′. As such, the outer wall 62, 62′, the inner wall 64, 64′, and the cross member 68, 68′ of both the first and second vertical protrusions 54, 56 cooperate to define the respective protrusion gap 66, 66′. The cross member 68, 68′ of each of the vertical protrusions 54, 56 is vertically spaced from the inner surface 50 of the hinge plate 40, such that an interface gap 74, 74′ is formed between a top surface 76, 76′ of the cross member 68, 68′ and the inner surface 50 of the hinge plate 40. The attachment plate 38 may form a first lip 78 on a first side 77 of the attachment plate 38 and a second lip 80 on a second side 79 of the attachment plate 38. Both the first lip 78 and the second lip 80 may be fixed within the interface gap 74, 74′ of the first and second vertical protrusion 54, 56, respectively. Specifically, both the first and the second lip 78, 80 may be fixed to a first interface member 82 and a second interface member 84, respectively, and the first and the second interface members 82, 84 may be fixed within the interface gap 74, 74′ of the first and the second vertical protrusion 54, 56, respectively.

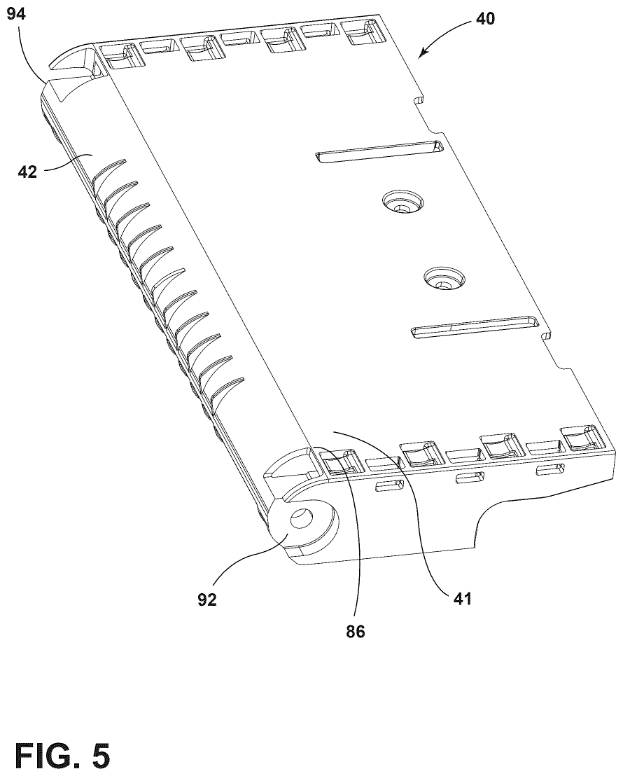

Referring now to FIG. 5, the pivot member 42 is coupled to and positioned at a front portion 41 of the hinge plate 40, such that the pivot member 42 is positioned proximate to the front portion 34 of the support bracket 28. Further, the pivot member 42 may be aligned with a front edge 86 of the hinge plate 40. The pivot member 42 may be integrally formed with the hinge plate 40, and as such, may be integrally formed with the support bracket 28 when the hinge plate 40 is integrally formed with the support bracket 28. The pivot member 42 may form a convex surface configured to interface with the calf rest 36 and facilitate the pivoting of the calf rest 36 relative to the hinge plate 40. The pivot member 42 further includes a first hinge mount 92 and a second hinge mount 94. The first hinge mount 92 and the second hinge mount 94 are both coupled with the front portion 41 of the hinge plate 40 and positioned on opposite sides of the hinge plate 40. Additionally, the first hinge mount 92 may be positioned adjacent to the first vertical protrusion 54 and the second hinge mount 94 may be positioned adjacent to the second vertical protrusion 56.

Referring back to FIG. 2A-2C, the calf rest 36 is coupled to the hinge plate 40 via the pivot member 42 and is configured to pivot about a first pivot axis 96 defined by the pivot member 42. Specifically, the calf rest 36 is coupled with both the first hinge mount 92 and the second hinge mount 94 of the pivot member 42.

With continued reference to FIGS. 2A-2C, the calf rest 36 is formed of a base member 98, an intermediary member 100, and an end member 101. The base member 98 is pivotably attached to both the first hinge mount 92 and the second hinge mount 94 via a first hinge receiver 102 and a second hinge receiver 104, respectively. As such, the base member 98 may be pivotably coupled with the hinge plate 40 to facilitate the pivoting of the calf rest 36 relative to the hinge plate 40 and the support bracket 28.

With continued reference to FIGS. 2A-2C, the intermediary member 100 is slidably coupled with the base member 98, such that the intermediary member 100 may translate relative to the base member 98. Specifically, the intermediary member 100 is configured to receive the base member 98 within an interior formed by the intermediary member 100. As such, a first set of dimensions defined by the base member 98 may be less than a second set of dimensions defined by the intermediary member 100. Accordingly, the base member 98 may be received into and passed out of the interior defined by the intermediary member 100, as the intermediary member 100 translates relative to the base member 98. In other words, the intermediary member 100 may be telescopically coupled to the base member 98.

Still referring to FIGS. 2A-2C, the end member 101 is slidably coupled with the intermediary member 100, such that the end member 101 may translate relative to the intermediary member 100. Specifically, the end member 101 is configured to receive the intermediary member 100 within an interior formed by the end member 101. As such, the second set of dimensions defined by the intermediary member 100 may be less than a third set of dimensions defined by the end member 101. Accordingly, the intermediary member 100 may be received into and passed out of the interior defined by the end member 101 as the end member 101 translates relative to the intermediary member 100. In other words, the end member 101 may be telescopically coupled to the intermediary member 100.

As shown in FIG. 2A, when the calf rest 36 is in the retracted position R, the base member 98 may be substantially received within the interior defined by the intermediary member 100 and the intermediary member 100 may be substantially received into the interior defined by the end member 101. Consequently, in the retracted position R, both the base member 98 and the intermediary members 100 are substantially disposed within the interior formed by the end member 101.

As shown in FIG. 2B, in the intermediary position I, the base member 98 is only partially received within the interior defined by the intermediary member 100. Likewise, the intermediary member 100 is only partially received within the interior defined by the end member 101.

As shown in FIG. 2C, in the extended position E, the base member 98 is positioned such that a substantial majority of the base member 98 is removed from the interior of the intermediary member 100. In other words, in the extended position E, only a front portion of the base member 98 may be received within the interior defined by the intermediary member 100. Likewise, in the extended position E, the intermediary member 100 is positioned such that a substantial majority of the intermediary member 100 is removed from the interior of the end member 101. In other words, in the extended position E, only a front portion of the intermediary member 100 may be received within the interior defined by the end member 101. Consequently, the calf rest 36 in the retracted position R has a first length that is less than a second length of the calf rest 36 in the intermediate position I. Further, the calf rest 36 in the extended position E has a third length that is greater than the second length of the calf rest 36 when in the intermediate position I.

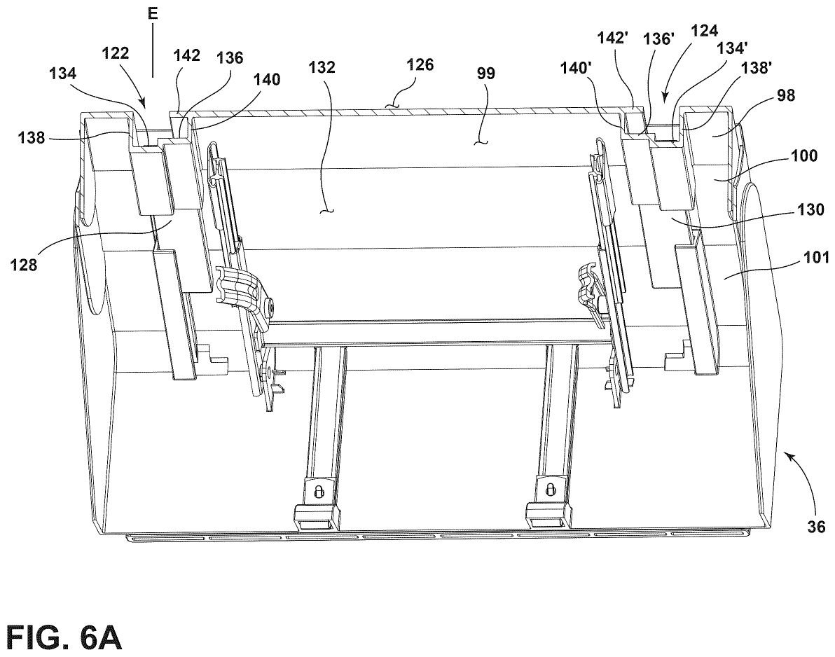

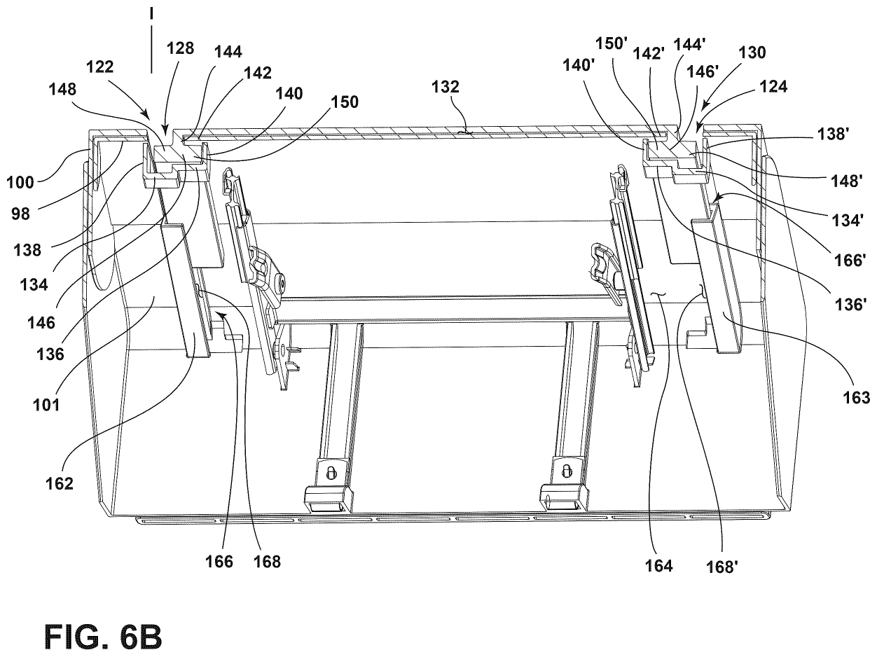

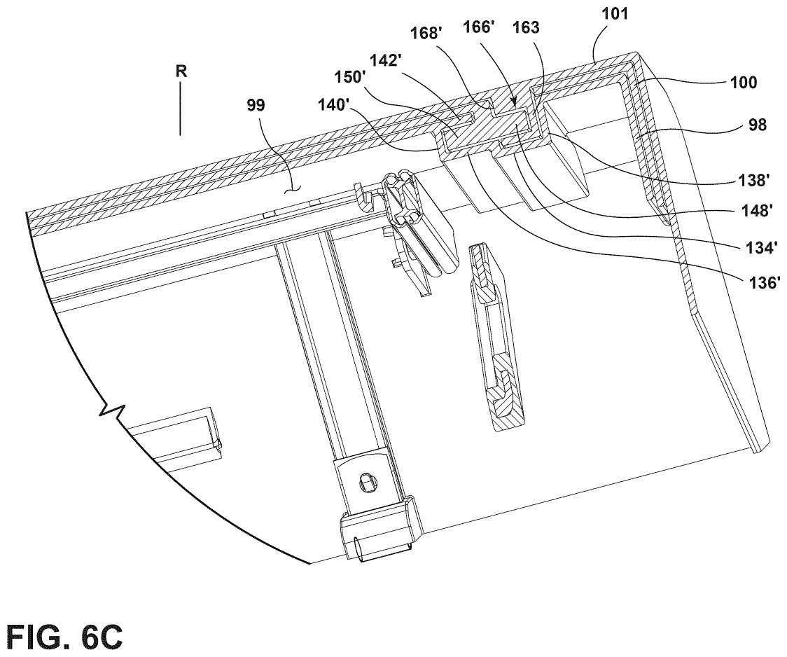

Referring now to FIG. 6A, the calf rest 36 is shown in the extended position E. As shown, the intermediary member 100 is slidably coupled with the base member 98 via a pair of base grooves 122, 124 formed in an exterior surface 126 of the base member 98 and a pair of intermediary projections 128, 130 that vertically extend from an inner surface 132 of the intermediary member 100. Specifically, each of the pair of base grooves 122, 124 is formed by the exterior surface 126 of the base member 98 and vertically extend towards the interior surface 99 of the base member 98. Each base groove 122, 124 forms a bilevel interior, such that a first surface 134, 134′ of each base groove 122, 124 is disposed vertically inferior relative to a second surface 136, 136′ of each groove 122, 124.

With reference still to FIG. 6A, a first wall 138, 138′ of each base groove 122, 124 is positioned adjacent to and extends vertically from the first surface 134, 134′ of each base groove 122, 124 towards the interior surface 99 of the base member 98. A second wall 140, 140′ of each base groove 122, 124 is positioned adjacent to and extends vertically from the second surface 136, 136′ of each base groove 122, 124 towards the interior surface 99 of the base member. The second wall 140, 140′ may extend at an oblique angle from the second surface 136, 136′ such that a portion of the interior surface 99 of the base member 98 forms an overhang 142, 142′ that extends over a portion of the respective second surface 136, 136′ of each base groove 122, 124. Alternatively, each of the second walls 140, 140′ may extend substantially perpendicular to the second surface 136, 136′ and a portion of the interior surface 99 of the base member 98 may extend over a portion of the second surface 136, 136′ of each base groove 122, 124 to form the respective overhang 142, 142′.

Referring now to FIG. 6B, the calf rest 36 is shown in the intermediate position I. As shown, each intermediary projection 128, 130 formed by the inner surface 132 of the intermediary member 100 forms a substantially rectangular shape and extends across the length of the intermediary member 100. Each intermediary projection 128, 130 includes a lateral stem 144, 144′ which inwardly extends vertically from the inner surface 132 of the intermediary member 100, and a protrusion block 146, 146′ formed at a distal-most end of the lateral stem 144, 144′ relative to the inner surface 132 of the intermediary member 100. The lateral stem 144, 144′ may divide the protrusion block 146, 146′ into a first portion 148, 148′ and a second portion 150, 150′.

Referring still to FIG. 6B, each of the intermediary projections 128, 130 are slidably coupled, respectively, with the pair of base grooves 122, 124. Specifically, the second portion 150, 150′ of each protrusion block 146, 146′ is interfaced with and positioned adjacent to the second surface 136, 136′ and the second wall 140, 140′ of each respective base groove 122, 124. Specifically, an exterior surface of the second portion 150, 150′ of each protrusion block 146, 146′ may be substantially flush with both the second surface 136, 136′ and the second wall 140, 140′. Further, the overhang 142, 142′ may be positioned between the inner surface 132 of the intermediary member 100 and the exterior surface of the second portion 150, 150′. As such, the overhang 142, 142′ may interface with and retain the second portion 150, 150′ within the respective groove 122, 124, consequently, at least partially maintaining the intermediary projections 128, 130 within the respective base groove 122, 124. The first portion 148, 148′ of the protrusion block 146, 146′ extends over the first surface 134, 134′ of the respective base groove 122, 124, such that a gap is defined between each first portion 148, 148′ and the first surface 134, 134′. Further, each first portion 148, 148′ is placed adjacent to, but is spaced from the respective first wall 138, 138′, such that a gap is defined between the first portions 148, 148′ and the respective first walls 138, 138′.

With continued reference to FIG. 6B, the end member 101 is slidably coupled with the intermediary member 100 via the interfacing of a pair of end projections 162, 163 with the intermediary projections 128, 130. The pair of end projections 162, 163 inwardly extend vertically from an inner surface 164 of the end member 101. Each of the pair of end projections 162, 163 forms an end track 166, 166′ that extends a length of each of the end projections 162, 163. Each end track 166, 166′ is formed in an inner side surface 168, 168′ of each end projection 162, 163, and extends inwards towards a centerline of each end projection 162, 163. Each of the intermediary projections 128, 130 are slidably coupled with each of the end projections 162, 163, respectively. Specifically, the first portion 148, 148′ of each intermediary projection 128, 130 is slidably coupled within each end track 166, 166′, respectively. Accordingly, each end projection 162, 163 can slide relative to the respectively coupled intermediary projection 128, 130.

Referring now to FIG. 6C, the calf rest 36 is shown in the retracted position. As shown, when the calf rest 36 is in the retracted position R, both the intermediary projections 128, 130 and the end projections 162, 163 are positioned within the respective base groove 122, 124. Specifically, the end projections 162, 163 are disposed within the respective gap formed between the first portion 148, 148′ of each intermediary projection 128, 130 and the first surface 134, 134′ and the first wall 138, 138′ of each base groove 122, 124.

Referring back to FIG. 3, the calf support mechanism 32 further includes a connector plate 170 coupled with the inner surface 29 of the support bracket 28. The connector plate 170 is positioned adjacent to the front portion 34 of the support bracket 28 and may be substantially in alignment with the hinge plate 40 and the attachment plate 38.

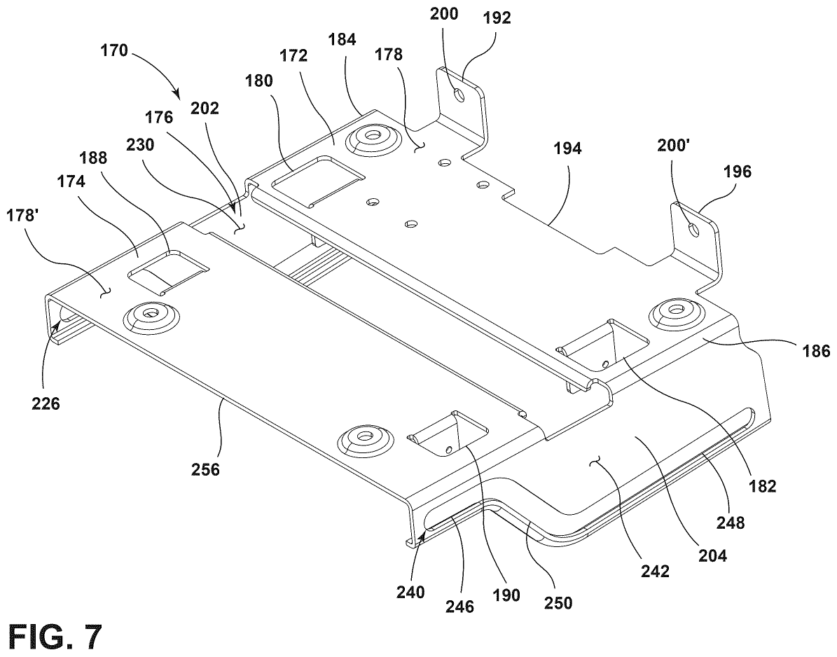

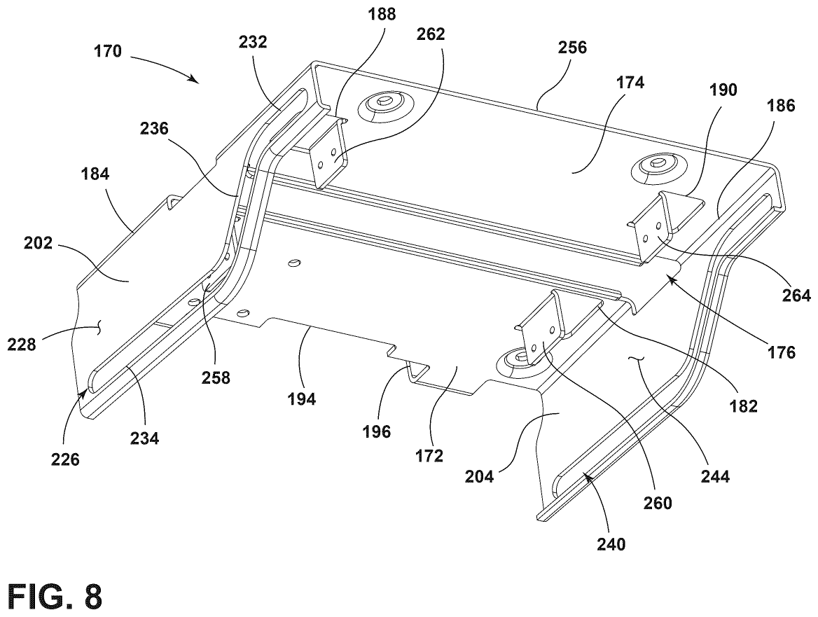

With reference to FIGS. 7 and 8, the connector plate 170 is formed of a first top plate 172 and a second top plate 174 that is laterally spaced from the first top plate 172 such that a connector gap 176 is defined between the first and the second top plates 172, 174. Both the first top plate 172 and the second top plate 174 provide a top surface 178, 178′ that is positioned adjacent to the inner surface 29 of the support bracket 28 when the connector plate 170 is coupled with the support bracket 28.

Still referring to FIGS. 7 and 8, a first connector aperture 180 and a second connector aperture 182 may be formed by the first top plate 172, wherein the first connector aperture 180 may be positioned adjacent to a first side 184 of the connector plate 170 and the second connector aperture 182 may be positioned adjacent to a second side 186 of the connector plate 170. Likewise, a third connector aperture 188 and a fourth connector aperture 190 may be formed by the second top plate 174, wherein the third connector aperture 188 is positioned adjacent to the first side 184 of the connector plate 170 and the fourth connector aperture 190 is positioned adjacent to the second side 186 of the connector plate 170. Additionally, a first connector flange 192 is positioned at and extends from a front portion 194 of the connector plate 170 and is positioned adjacent to the first side 184 of the connector plate 170. A second connector flange 196 is positioned at and extends from the front portion 194 of the connector plate 170 and is positioned adjacent to the second side 186 of the connector plate 170.

With reference to both FIGS. 3, 7, and 8, the connector plate 170 may be fixed to the inner surface 29 of the support bracket 28 via bolts, welds, or other various fasteners. Specifically, a fastener may be introduced through a fastener aperture 200, 200′ formed by each of the first and second connector flanges 192, 196. The fasteners may couple the connector plate 170, via the first and the second connector flange 192, 196 to the front portion 34 of the support bracket 28.

With continued reference to FIGS. 7 and 8, a first overhang 202 laterally extends the length of the first side 184 of the connector plate 170, connecting the first top plate 172 to the second top plate 174. Further, the first overhang 202 extends vertically towards the floor 24 of the vehicle 22 from both the first and the second top plates 172, 174. A second overhang 204 laterally extends the length of the second side 186 of the connector plate 170, further connecting the first top plate 172 with the second top plate 174. Further, the second overhang 204 likewise extends vertically towards the floor 24 of the vehicle 22 from both the first and the second top plates 172, 174.

With continued reference to FIGS. 7 and 8, a first guiding slot 226 is formed by the first overhang 202. Specifically, the first guiding slot 226 forms a channel through an exterior surface 228 of the first overhang 202 to an inner surface 230 of the first overhang 202. The first guiding slot 226 laterally extends substantially the entire length of the first overhang 202. A first length 232 of the first guiding slot 226 may be positioned vertically superior relative to a second length 234 of the first guiding slot 226. Consequently, a third length 236 of the first guiding slot 226 may extend at an angle to connect the first and second lengths 232, 234 of the first guiding slot 226. As such, the first guiding slot 226 may define a non-linear track.

With continued reference to FIGS. 7 and 8, a second guiding slot 240 is formed by the second overhang 204. Specifically, the second guiding slot 240 forms a channel through the exterior surface 242 of the second overhang 204 to an inner surface 244 of the second overhang 204. The second guiding slot 240 laterally extends substantially the entire length of the second overhang 204. Specifically, a first length 246 of the second guiding slot 240 may be positioned vertically superior relative to a second length 248 of the second guiding slot 240. Consequently, a third length 250 of the second guiding slot 240 may extend at an angle to connect the first and second lengths 246, 248 of the second guiding slot 240. Consequentially, the second guiding slot 240 may define a non-linear track.

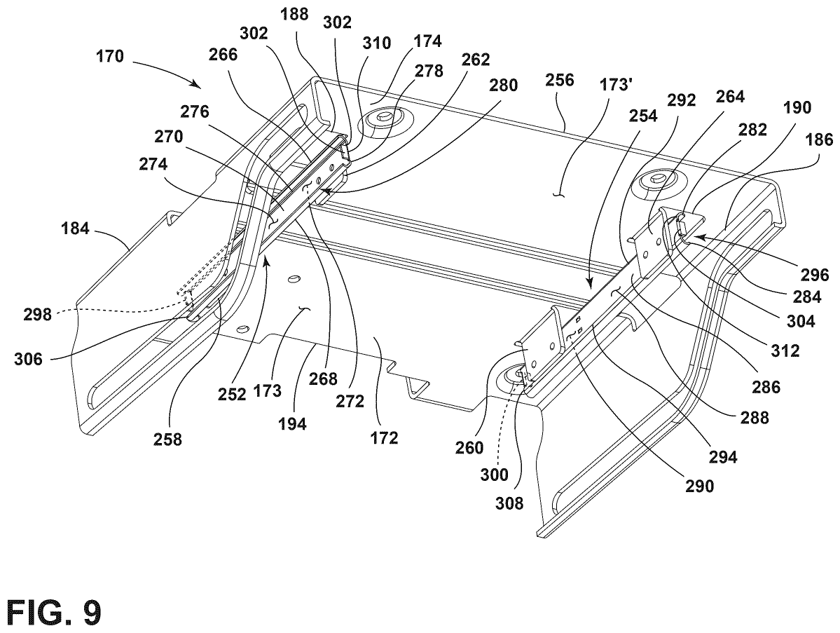

Referring now to FIG. 9, the calf support mechanism 32 may include a first side plate 252 and a second side plate 254. Both the first and second side plates 252, 254 are positioned beneath the connector plate 170 and extend laterally towards the front portion 194 of the connector plate 170 and towards a rear portion 256 of the connector plate 170. The first and the second side plates 252, 254 are positioned beneath and attached to the connector plate 170 via a first plate flange 258, a second plate flange 260, a third plate flange 262, and a fourth plate flange 264.

Still referring to FIG. 9, the first and second plate flanges 258, 260 extend specifically from the inner surface 173 of the first top plate 172 and are positioned adjacent to the first and second sides 184, 186, respectively, of the connector plate 170. A view of the first side plate flange 258 is best provided in FIG. 8. Moreover, the first plate flange 258 is positioned adjacent to the first connector aperture 180, and the second plate flange 260 is positioned adjacent to the second connector aperture 182. The third and the fourth plate flanges 262, 264 extend specifically from the inner surface 173′ of the second top plate 174 and are positioned on the first and the second sides 184, 186, respectively, of the connector plate 170. Moreover, the third plate flange 262 is positioned adjacent to the third connector aperture 188, and the fourth plate flange 264 is positioned adjacent to the fourth connector aperture 190.

With continued reference to FIG. 9, the first side plate 252 is coupled with and laterally extends between the first plate flange 258 and the third plate flange 262. The second side plate 254 is coupled with and laterally extends between the second plate flange 260 and the fourth plate flange 264. The first and the second side plates 252, 254 may be coupled with the respective plate flanges 258, 262 via bolts, welds, or through other various fasteners. Alternatively, the first and second side plate 252, 254 may be integrally formed with the respective plate flanges 258, 260, 262, 264, such that the first side plate 252 and the second side plate 254 are integrally formed with the connector plate 170.

With continued reference to FIG. 9, the first side plate 252 forms a first curved wall 266, a second curved wall 268, and a vertical wall 270. The vertical wall 270 of the first side plate 252 has an inner surface 272 and an outer surface 274, wherein the first side plate 252 is attached to the first and the third plate flanges 258, 262 via the inner surface 272 of the vertical wall 270. The first curved wall 266 of the first side plate 252 laterally extends from a top portion 276 of the vertical wall 270 outwards towards first overhang 202. The second curved wall 268 of the first side plate 252 laterally extends from a bottom portion 278 of the vertical wall 270 outwards towards the first overhang 202. Accordingly, a side plate track 280 is formed between the outer surface 274 of the vertical wall 270, the first curved wall 266, and the second curved wall 268.

With continued reference to FIG. 9, the second side plate 254 likewise forms a first curved wall 282, a second curved wall 284, and a vertical wall 286. The vertical wall 286 of the second side plate 254 has an inner surface 288 and an outer surface 290, wherein the second side plate 254 is attached to the second and the fourth plate flanges 260, 264 via the inner surface 288 of the vertical wall 286. The first curved wall 282 of the second side plate 254 laterally extends from a top portion 292 of the vertical wall 286 outwards towards the second overhang 204. The second curved wall 284 of the second side plate 254 laterally extends from a bottom portion 294 of the vertical wall 286 outwards towards the second overhang 204. Accordingly, a side plate track 296 is formed between the outer surface 290 of the vertical wall 286, the first curved wall 282, and the second curved wall 284.

With continued reference to FIG. 9, the first side plate 252 and the second side plate 254 each form a front stop flange 298, 300 and a rear stop flange 302, 304. The front stop flange 298, 300 is positioned at a front edge 306, 308 of each respective vertical wall 270, 286 and outwardly extends towards the respective overhang 202, 204. Further, the front stop flange 298, 300 extends across a portion of the height of the vertical wall 270, 286 of each side plate 252, 254. Consequentially, the front stop flanges 298, 300 are formed such that the front stop flanges 298, 300 extend over a portion of the respective side plate track 280, 296 of each side plate 252, 254. The rear stop flanges 302, 304 are positioned at a rear edge 310, 312 of the respective vertical wall 270, 286 and outwardly extend towards the respective overhang 202, 204. Further, the rear stop flanges 302, 304 extend across a portion of the height of the vertical wall 270, 286 of each side plate 252, 254. Consequentially, the rear stop flanges 302, 304 are formed such that the rear stop flanges 302, 304 extend over a portion of the side plate track 280, 296 of the respective side plate 252, 254.

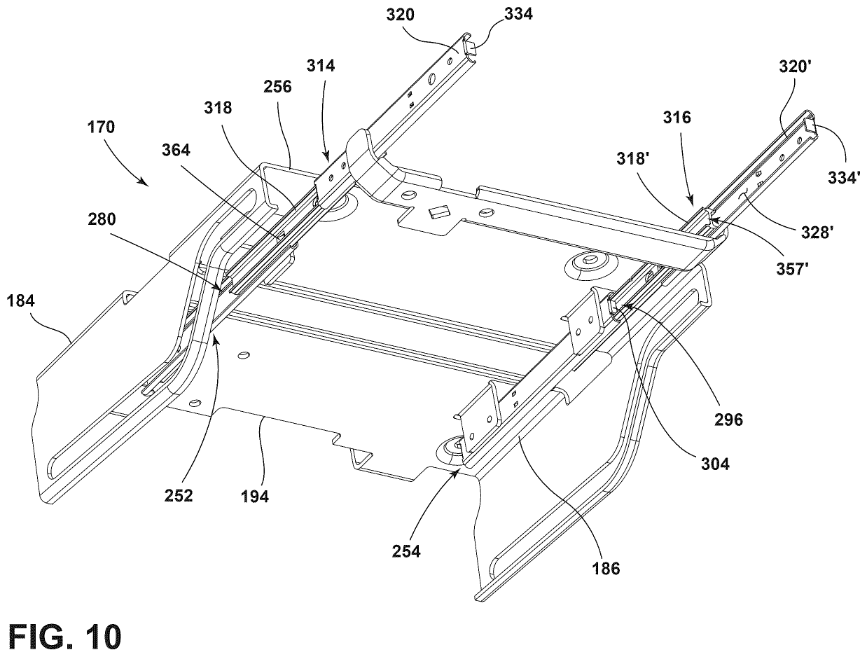

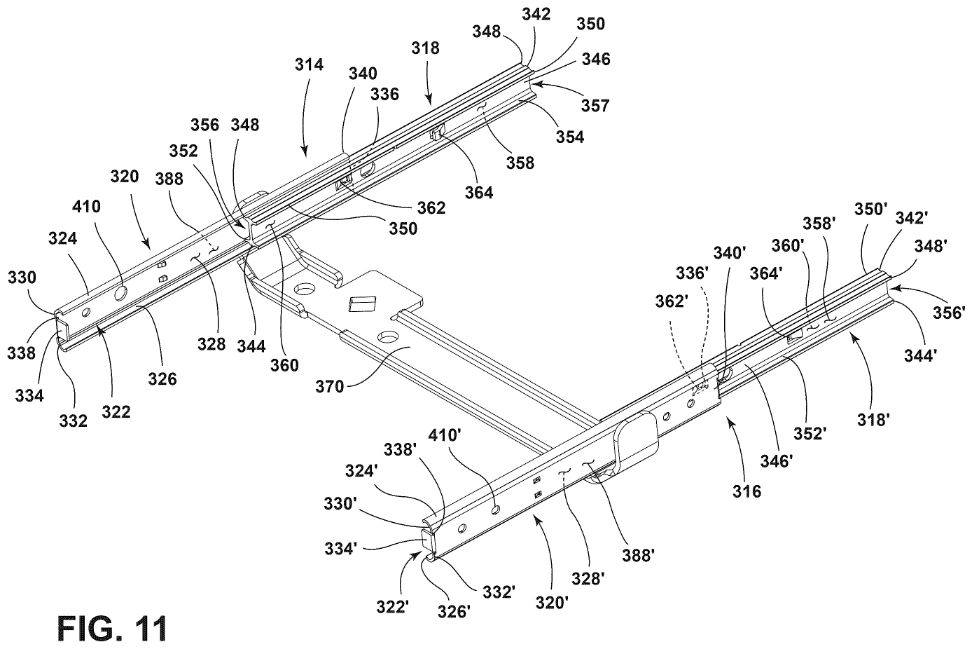

Referring now to FIGS. 10 and 11, the calf support mechanism 32 further includes a first link assembly 314 and a second link assembly 316. The first link assembly 314 is positioned beneath the connector plate 170 and is slidably coupled with the first side plate 252. The second link assembly 316 is positioned beneath the connector plate 170 and is slidably coupled with the second side plate 254.

Referring still to FIGS. 10 and 11, both the first link assembly 314 and the second link assembly 316 include a guide link 318, 318′ and a slide link 320, 320′.

As shown in FIGS. 10 and 11, the slide links 320, 320′ are slidably coupled with the guide links 318, 318′, such that the slide links 320, 320′ can laterally translate relative to the guide links 318, 318′. Specifically, both slide links 320, 320′ each provide a sliding track 322, 322′ formed of a first slide link wall 324, 324′ and a second slide link wall 326, 326′. Both the first slide link wall 324, 324′ and the second slide link wall 326, 326′ extend along the length of the respective slide link 320, 320′. Further, both the first slide link wall 324, 324′ and the second slide link wall 326, 326′ laterally extend from an inner surface 328, 328′ of the respective slide link 320, 320′. The first slide link wall 324, 324′ is positioned adjacent to a top side 330, 330′ of the respective slide link 320, 320′ and the second slide link wall 326, 326′ is positioned adjacent to a bottom side 332, 332′ of the respective slide link 320, 320′. Consequentially, the sliding track 322, 322′ of each slide link 320, 320′ is formed between the respective first slide link wall 324, 324′, the second slide link wall 326, 326′, and the inner surface 328, 328′.

Referring still to FIGS. 10 and 11 each of the slide links 320, 320′ form a rear link flange 334, 334′ and a front link flange 336, 336′. Each rear link flange 334, 334′ is formed at a rear portion 338, 338′ of each slide link 320, 320′, and extends a portion of the height of the respective slide link 320, 320′. Further, each rear link flange 334, 334′ outwardly extends from the inner surface 328, 328′ of the respective slide link 320, 320′. The front link flanges 336, 336′ are formed at a front portion 340, 340′ of the respective slide link 320, 320′, and extend a portion of the height of the respective slide link 320, 320′. Further, each front link flange 336, 336′ outwardly extends from the inner surface of the respective slide link 320, 320′.

Referring still to FIGS. 10 and 11, the guide link 318 of the first link assembly 314 and the guide link 318′ of the second link assembly 316 are each formed of a top plane 342, 342′ and a bottom plane 344, 344′ that laterally extend substantially parallel to one another. Additionally, the guide links 318, 318′ of the first link assembly 314 and the second link assembly 316 are further formed of a median wall 346, 346′ that vertically extends between the respective top planes 342, 342′ and the respective bottom plane 344, 344′. The median walls 346, 346′ may vertically extend substantially perpendicular to both the respective top plane 342, 342′ and bottom plane 344, 344′. Further, the median walls 346, 346′ may be positioned at the centerline of the respective top plane 342, 342′ to divide each top plane 342, 342′ into an outer portion 348, 348′ and an inner portion 350, 350′. Likewise, the median walls 346, 346′ may be positioned at the centerline of the respective bottom plane 344, 344′ to divide each bottom plane 344, 344′ into an outer portion 352, 352′ and an inner portion 354, 354′. Accordingly, each of the guide links 318, 318′ provides an outer guide track 356, 356′ formed between an outer surface 358, 358′ of the median wall 346, 346′, the outer portion 348, 348′ of the top plane 342, 342′, and the outer portion 352, 352′ of the bottom plane 344, 344′. Likewise, each of the guide links 318, 318′ provides an inner guide track 357, 357′ between an inner surface 360, 360′ of the median wall 346, 346′, the inner portion 350, 350′ of the top plane 342, 342′, and the inner portion 354, 354′ of the bottom plane 344, 344′.

With continued reference to FIGS. 10 and 11, the median wall 346, 346′ of each guide link 318, 318′ may provide an outer protrusion 362, 362′ and an inner protrusion 364, 364′. Each outer protrusion 362, 362′ may be formed by a portion of the respective median wall 346, 346′ that curves towards the outer guide track 356, 356′. As such, the outer protrusion 362, 362′ may enter and be interposed within the outer guide track 356, 356′. Each inner protrusion 364, 364′ may be formed by a portion of the respective median wall 346, 346′ that curves towards the inner guide track 357, 357′ of the vehicle seating assembly 20. As such, each inner protrusion 364, 364′ may enter and be interposed within the respective inner guide track 357, 357′.

Referring still to FIGS. 10 and 11, the guide link 318, 318′ of both the first link assembly 314 and the second link assembly 316 are slidably coupled to the first side plate 252 and the second side plate 254, respectively. Specifically, the rear stop flange 302, 304 of each side plate 252, 254 is slidably disposed within the inner guide track 357, 357′ of the respective guide link 318, 318′. Additionally, the inner protrusion 364, 364′ of each guide link 318, 318′ may be interposed within the respective side plate track 280, 296. Accordingly, the guide links 318, 318′ may translate relative to the slide plates 252, 254 into and out of the respective side plate track 280, 296.

Referring still to FIGS. 10 and 11, the guide link 318, 318′ of both the first link assembly 314 and the second link assembly 316 is slidably coupled to the slide link 320, 320′ of the first link assembly 314 and the second link assembly 316, respectively. As such, the guide link 318 and the slide link 320 of the first link assembly 314 are configured to translate relative to one another. Likewise, the guide link 318′ and the slide link 320′ of the second link assembly 316 are configured to translate relative to one another. Specifically, the outer portion 348, 348′ of the top plane 342, 342′ and the outer portion 352, 352′ of the bottom plane 344, 344′ of the guide links 318, 318′ are interfaced with the first slide link wall 324, 324′ and the second slide link wall 326, 326′ of the respective slide link 320, 320′. In other words, the inner guide tracks 357, 357′ are received by the respective sliding track 322, 322′.

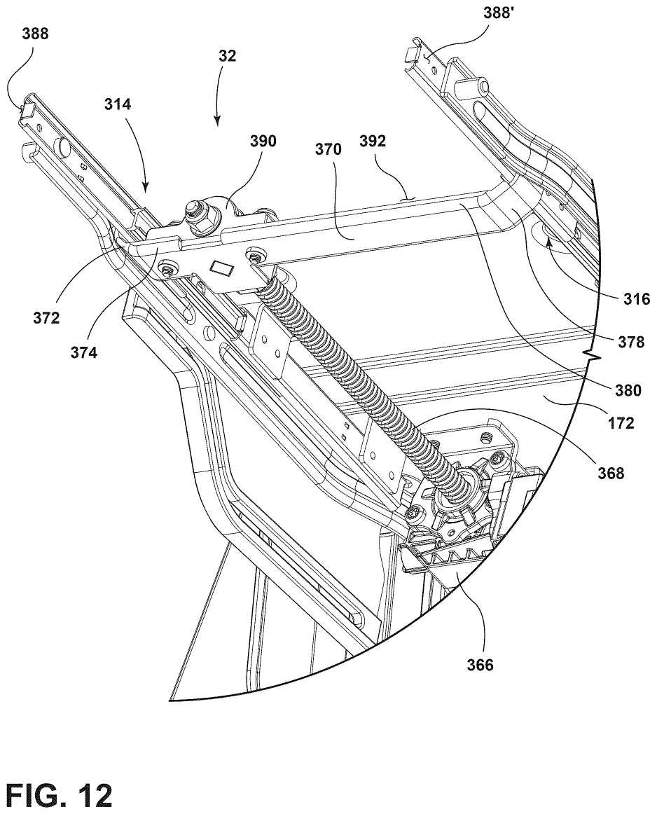

With reference now to FIG. 12, the calf support mechanism 32 further includes a calf support actuator 366, an actuating element 368, and a crossbar 370. The calf support actuator 366 is positioned beneath the connector plate 170 and fixed to the inner surface 173 of the first top plate 172. The calf support actuator 366 may be fixed to the inner surface 173 of the first top plate 172 via bolts, welds, or other various fasteners. The calf support actuator 366 may be a brushed DC motor, a brushless DC motor, or various other types of motors and/or drive mechanisms suitable to power the transition of the calf support mechanism 32.

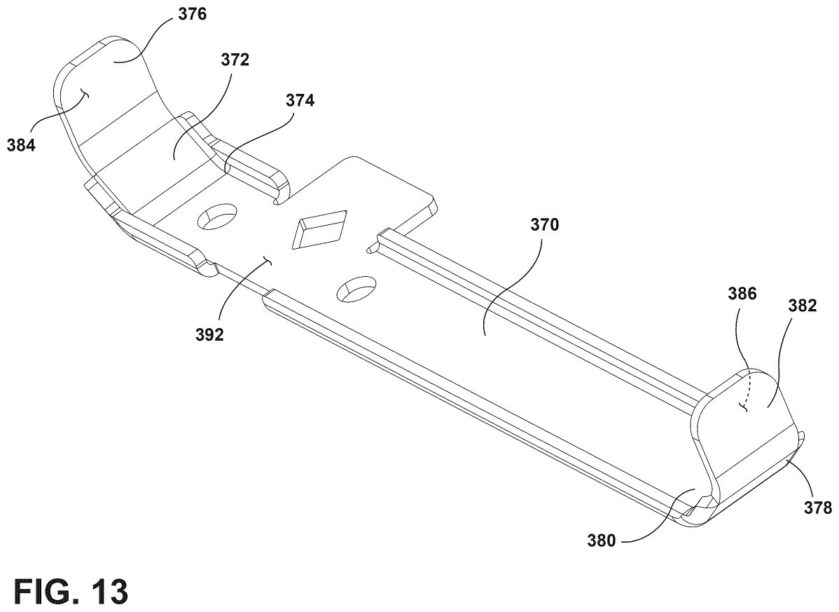

Referring now to FIGS. 12-13, the crossbar 370 laterally extends between and connects the first link assembly 314 and the second link assembly 316. Specifically, the crossbar 370 forms a first arm 372 that vertically extends at an obtuse angle from a first end 374 of the crossbar 370, forming a planar portion 376 that vertically extends substantially perpendicular to the crossbar 370 at a distal end of the first arm 372 relative to the crossbar 370. Likewise, the crossbar 370 forms a second arm 378 that vertically extends at an obtuse angle from a second end 380 of the crossbar 370, forming a planar portion 382 that vertically extends substantially perpendicular to the crossbar 370 at a distal end of the second arm 378 relative to the crossbar 370. An inner surface 384 of the planar portion 376 of the first arm 372 is fixed to an outer surface 388 of the slide link 320 of the first link assembly 314. Likewise, an inner surface 386 of the planar portion 382 of the second arm 378 is fixed to an outer surface 388′ of the slide link 320′ of the second link assembly 316. As such, the first link assembly 314 is positioned adjacent to the inner surface 384 of the planar portion 376 of the first arm 372 of the crossbar 370, and the second link assembly 316 is positioned adjacent to the inner surface 386 of the planar portion 382 of the second arm 378 of the crossbar 370.

With continued reference to FIG. 12, the actuating element 368 laterally extends between the calf support actuator 366 and the crossbar 370. The actuating element 368 may be fixed to the crossbar 370 via a fixing anchor 390 attached to a top surface 392 of the crossbar 370. In operation, the actuating element 368 is configured to exert a force generated by the calf support actuator 366 to translate the crossbar 370 towards and away from the calf support actuator 366, transitioning the calf support mechanism 32 between the retracted position R, the intermediate position I, and the extended position E.

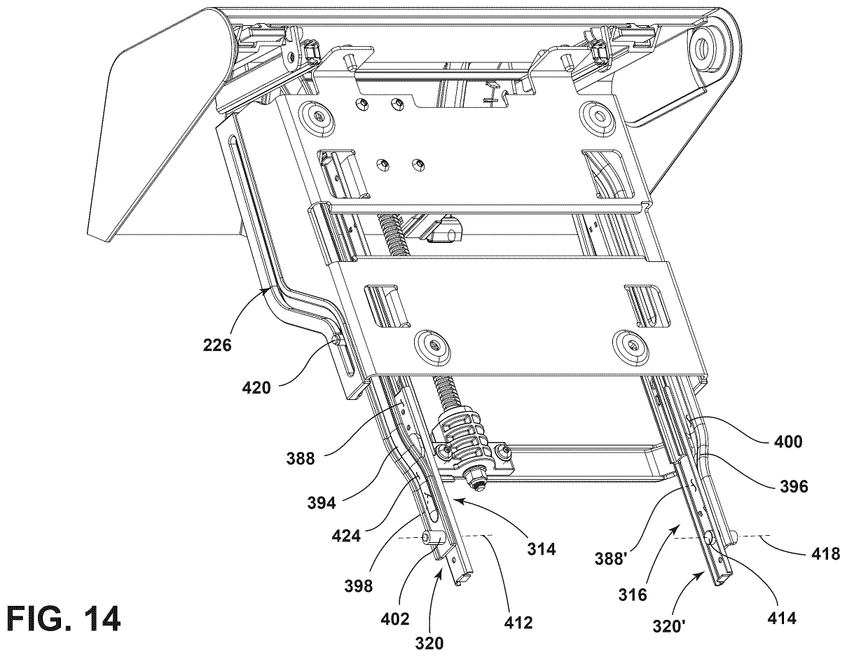

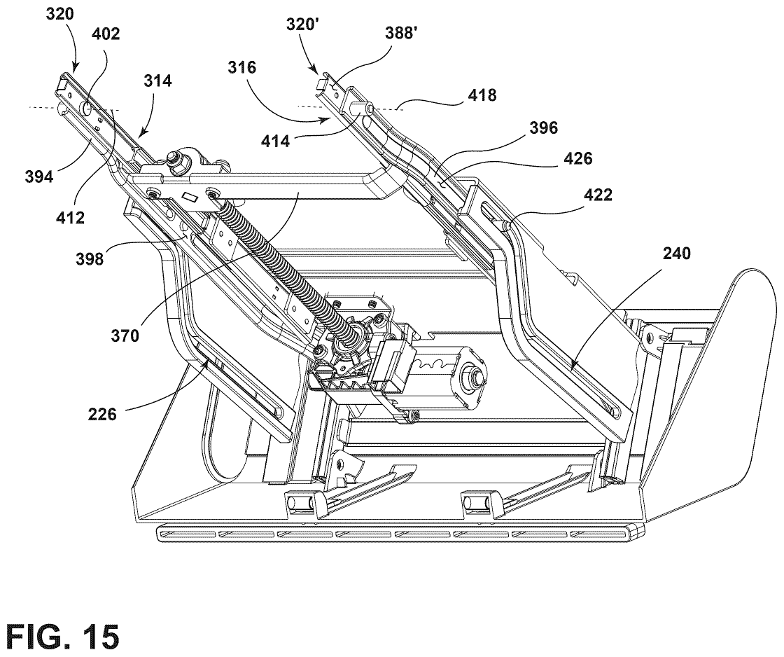

With reference now to FIGS. 14 and 15, the calf support mechanism 32 further includes a first guide member 394, and a second guide member 396. The first guide member 394 is pivotably coupled with the first link assembly 314. Likewise, the second guide member 396 is pivotably coupled with the second link assembly 316. Specifically, the first and the second guide member 394, 396 are pivotably coupled to the slide links 320, 320′ of the first and the second link assemblies 314, 316, respectively. Further, an inner surface 398 of the first guide member 394 and an inner surface 400 of the second guide member 396 may be positioned adjacent to the outer surface 388, 388′ of the respective slide link 320, 320′.

With continued reference to FIGS. 14 and 15, the first guide member 394 may be pivotably coupled with the slide link 320 of the first link assembly 314 via a first guide pivot shaft 402. Specifically, the first guide pivot shaft 402 is rotatably disposed through a slide link aperture 410 formed by the slide link 320 of the first link assembly 314 as shown in FIG. 11. As such, the first guide member 394 may pivot, relative to the slide link 320 of the first link assembly 314, about a second pivot axis 412 defined by the lateral extension of the first guide pivot shaft 402. Likewise, the second guide member 396 may be pivotably coupled with the slide link 320′ of the second link assembly 316 via a second guide pivot shaft 414. Specifically, the second guide pivot shaft 414 is disposed through a slide link aperture 410′ formed by the slide link 320′ of the second link assembly 316. As such, the second guide member 396 may pivot, relative to the slide link 320′ of the second link assembly 316, about a third pivot axis 418 defined by the lateral extension of the second guide pivot shaft 414.

With continued reference to FIGS. 14 and 15, both the first guide member 394 and the second guide member 396 form a guiding shaft 420, 422 that laterally extends outwards from an outer surface 424, 426 of the respective guide member 394, 396. The guiding shaft 420, 422 of both the first guide member 394 and the second guide member 396 is interposed within the first guiding slot 226 and the second guiding slot 240, respectively. As such, the movement of both the first guide member 394 and the second guide member 396 is controlled by the interaction between the guiding shafts 420, 422 and the respective guiding slots 226, 240. Consequentially, the movement of the guide members 394, 396 as the calf support mechanism 32 is transitioned between the retracted R, the intermediate I, and the extended position E is substantially aligned with the non-linear path formed by the guiding slots 226, 240.

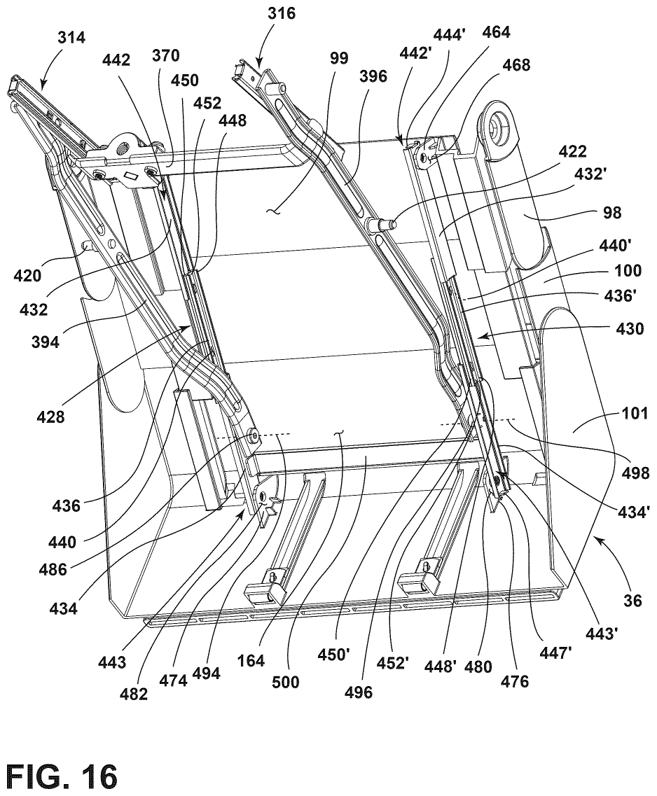

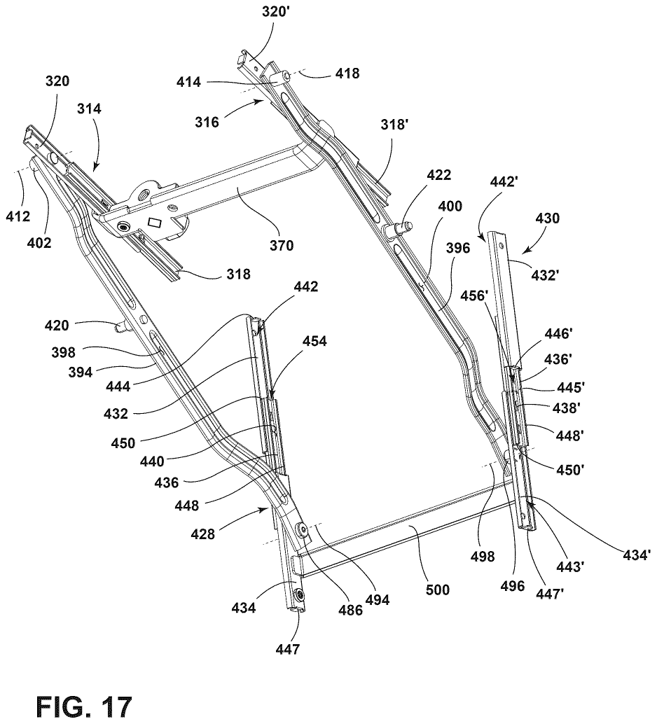

Now referring to FIGS. 16-17, the calf support mechanism 32 further includes a first dual-link assembly 428 and a second dual-link assembly 430. The first dual-link assembly 428 is coupled with the first guide member 394 and the calf rest 36. Likewise, the second dual-link assembly 430 is coupled to the second guide member 396 and to the calf rest 36.

Still referring to FIGS. 16-17, both the first dual-link assembly 428 and the second dual-link assembly 430 include an outer slide link 432, 432′, an inner slide link 434, 434′, and a dual guide link 436, 436′. The outer slide links 432, 432′ are each slidably coupled to an outer surface 438, 438′ of the respective dual guide link 436, 436′. The inner slide links 434, 434′ are each slidably coupled to the inner surface 440, 440′ of the respective dual guide links 436, 436′.

Referring still to FIGS. 16-17, both the outer slide links 432, 432′ and the inner slide links 434, 434′ of each dual-link assembly 428, 430 are substantially identical to the slide links 320, 320′ of the link assemblies 314, 316 described above. As such, the outer slide links 432, 432′ each form an outer sliding track 442, 442′, a rear link flange 444, 444′, and a front link flange 446, 446′. Likewise, the inner slide links 434, 434′ each form an inner sliding track 443, 443′, a rear link flange 445, 445′ and a front link flange 447, 447′.

With continued reference to FIGS. 16-17, the dual guide links 436, 436′ are substantially similar to the guide links 318, 318′ of the link assemblies 314, 316 described above. As such, the dual guide links 436, 436′ are each formed of a top plane 448, 448′, a bottom plane 450, 450′, and a median wall 452, 452′ that vertically extends between the respective top plane 448, 448′ and the bottom plane 450, 450′ to provide each dual guide link 436, 436′ with an inner guide track 454, 454′ and an outer guide track 456, 456′. Additionally, the median wall 452, 452′ of each dual guide link 436, 436′ may also form an outer protrusion and an inner protrusion in a substantially similar manner as the median walls 346, 346′ of the guide links 318, 318′ of the above-described link assemblies 314, 316.

Referring still to FIGS. 16-17, the outer slide link 432, 432′ of both the first dual-link assembly 428 and the second dual-link assembly 430 are slidably coupled with the outer slide track 456, 456′ of the respective dual guide link 436, 436′. Specifically, the outer guide track 456, 456′ of each dual guide link 436, 436′ is interposed within the outer sliding track 442, 442′ formed by the respective outer slide link 432, 432′.

With continued reference to FIGS. 16-17, the inner slide link 434, 434′ of both the first dual-link assembly 428 and the second dual-link assembly 430 are slidably coupled with the inner slide track 454, 454′ of the respective dual guide link 436, 436′. Specifically, the inner guide track 454, 454′ of each dual guide link 436, 436′ is interposed within the inner sliding track 443, 443′ formed by the respective inner slide link 434, 434′.

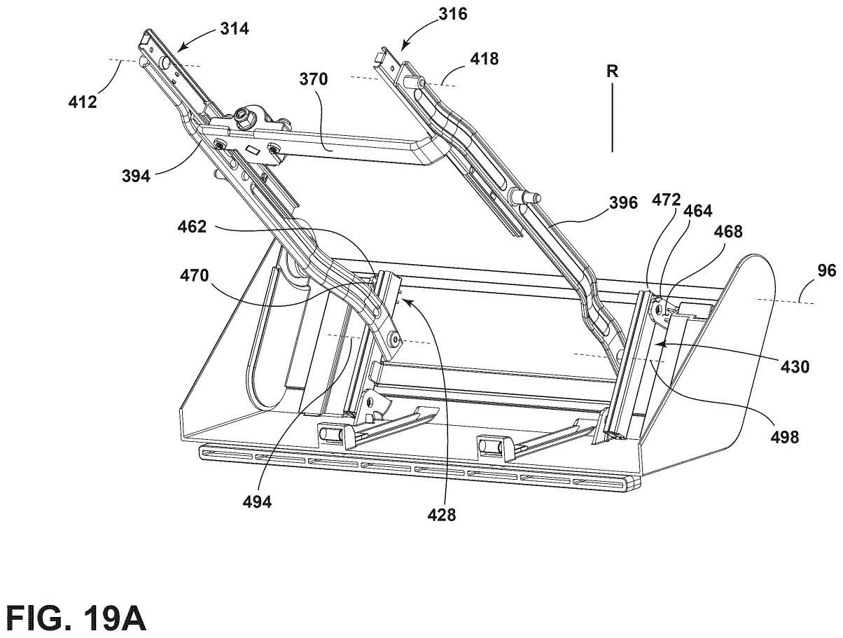

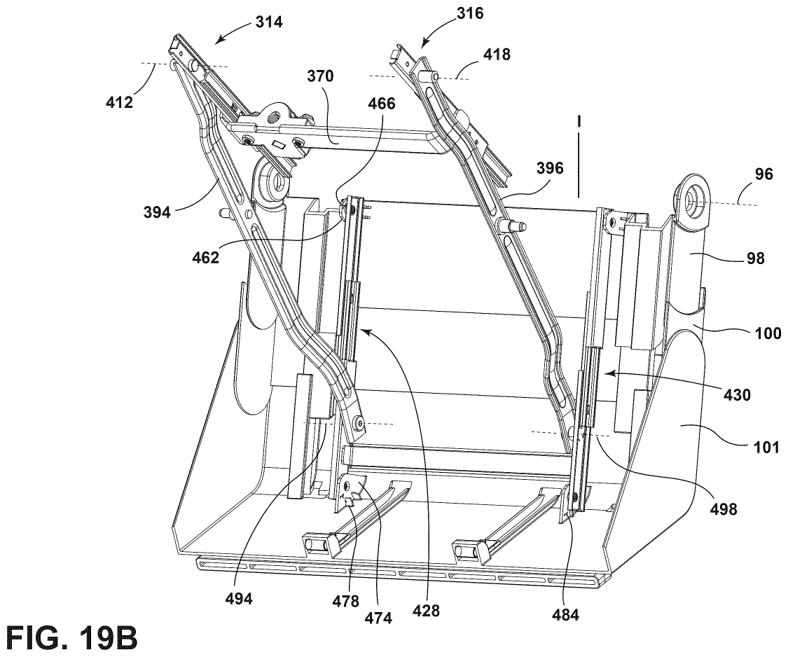

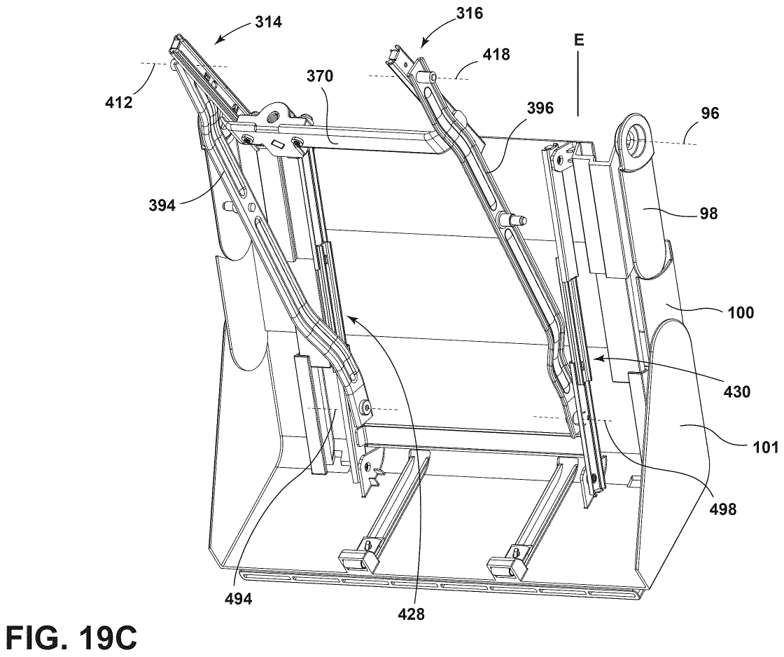

Referring still to FIG. 16, the outer slide link 432 of the first dual-link assembly 428 and the outer slide link 432′ of the second dual-link assembly 430 are fixed to the interior surface 99 of the base member 98 of the calf rest 36. Specifically, a first base flange 462 and a second base flange 464 vertically extend from the interior surface 99 of the base member 98. Both the first base flange 462 and the second base flange 464 each provide an outer surface 466, 468 and an inner surface 470, 472. The outer slide link 432 of the first dual-link assembly 428 is interfaced with and attached to the inner surface 470 of the first base flange 462. Likewise, the outer slide link 432′ of the second dual-link assembly 430 is interfaced with and attached to the inner surface 472 of the second base flange 464 as best shown in FIG. 19B.

Referring still to FIGS. 16-17, the inner slide link 434 of the first dual-link assembly 428 and the inner slide link 434′ of the second dual-link assembly 430 are fixed to the inner surface 164 of the end member 101 of the calf rest 36. Specifically, a first end flange 474 and a second end flange 476 vertically extend from the inner surface 164 of the end member 101. Both the first end flange 474 and the second end flange 476 each provide an outer surface 478, 480 and an inner surface 482, 484. The inner slide link 434 of the first dual-link assembly 428 is interfaced with and attached to the outer surface 478 of the first end flange 474. Likewise, the inner slide link 434′ of the second dual-link assembly 430 is interfaced with and attached to the outer surface 480 of the second end flange 476.

With continued reference to FIG. 16, the first guide member 394 is pivotably coupled with the inner slide link 434 of the first dual-link assembly 428, and the second guide member 396 is pivotably coupled with the inner slide link 434′ of the second dual-link assembly 430. Specifically, the first guide member 394 is pivotably coupled with the inner slide link 434 of the first dual-link assembly 428 via a third guide pivot shaft 486. As such, the first guide member 394 may pivot, relative to the inner slide link 434 of the first dual-link assembly 428, about a fourth pivot axis 494 defined by the lateral extension of the third guide pivot shaft 486. Likewise, the second guide member 396 may be pivotably coupled with the inner slide link 434′ of the second dual-link assembly 430 via a fourth guide pivot shaft 496. As such, the second guide member 396 may pivot, relative to the inner slide link 434′, about a fifth pivot axis 498 defined by the lateral extension of the fourth guide pivot shaft 496.

Referring still to FIGS. 16-17, a cross-link 500 is coupled with, and laterally extends between the first dual-link assembly 428 and the second dual-link assembly 430. Specifically, the cross-link 500 is coupled with the inner slide link 434 of the first dual-link assembly 428 and the inner slide link 434′ of the second dual-link assembly 430. Further, the cross-link 500 may form a substantially rectangular shape.

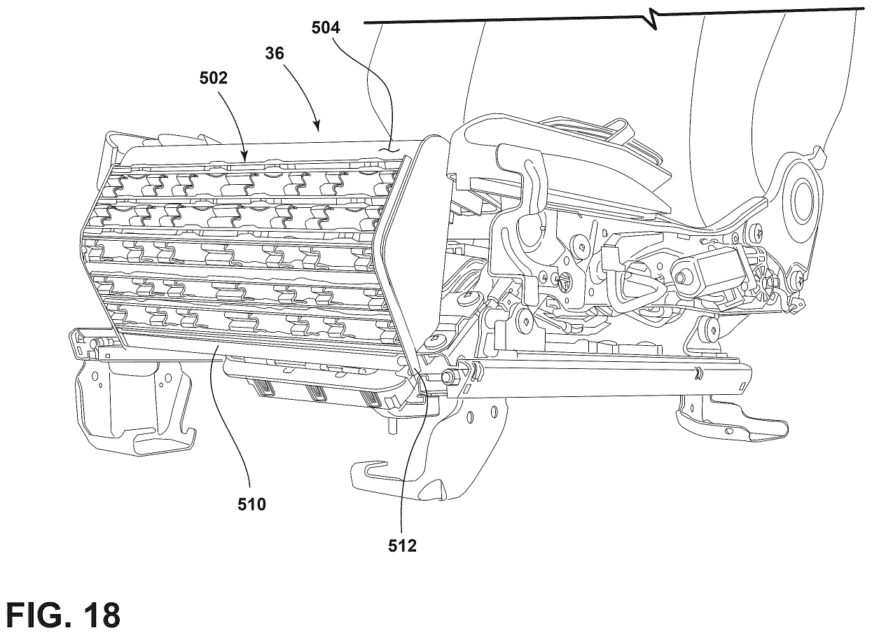

Referring now to FIG. 18, the calf support mechanism 32 may include an expandable trim member 502, coupled to the calf rest 36. The expandable trim member 502 is an elastic member configured to expand and retract in accordance with the position of the calf rest 36. The expandable trim member 502 may be an expandable metallic mesh formed of a plurality of interlinking metallic members configured to individually expand and retract to allow the expandable trim member 502 to expand and retract in accordance with the position of the calf rest 36. Additionally, the expandable trim member 502 may be formed of other materials suitable to facilitate the elastic expansion and retraction of the expandable trim member 502.

With continued reference to FIG. 18, the expandable trim member 502 may cover substantially an exterior surface 504 of the calf rest 36. In other words, the expandable trim member 502 may be coupled to and cover substantially the exterior surface 126 of the base member 98, the exterior surface 506 of the intermediary member 100, and the exterior surface 508 of the end member 101 of the calf rest 36. Further, the expandable trim member 502 may be coupled to the exterior surface 508 of the end member 101 via an end cap 510. The end cap 510 may form a substantially rectangular form and extend laterally, substantially parallel to a width of the end member 101. The end cap 510 may be attached at an end portion 512 of the expandable trim member 502 to at least partially fix the expandable trim member 502 to the end member 101.

In operation, the expandable trim member 502 expands in accordance with the expansion of the calf rest 36 from the retracted position R, to the intermediate position I, and to the extended position E. Likewise, the expandable trim member 502 retracts in accordance with the retraction of the calf rest 36 from the extended position E, to the intermediate position I, to the retracted position R. As such, the dimensions of the expandable trim member 502 alter in accordance with the position of the calf rest 36.

With reference to the above described figures and FIGS. 19A-19C, the operation of the above-described calf support mechanism 32 will subsequently be described. The user of the vehicle seating assembly 20 may activate the calf support actuator 366 to alter the position of the calf support mechanism 32, either to extend the calf rest 36, or to retract the calf rest 36. When the calf support mechanism 32 is in the retracted position R, the calf support actuator 366 exerts a force on the actuating element 368 causing the crossbar 370 to translate towards the end member 101 of the calf rest 36. As such, the crossbar 370 causes the slide link 320, 320′ of both the first link assembly 314 and the second link assembly 316 to slide relative to the respective guide link 318, 318′ towards the end member 101 of the calf rest 36. Consequentially, the first guide member 394 and the second guide member 396 are likewise translated towards the end member 101 of the calf rest 36. Further, as the first and the second guide member 394, 396 translate, the first and second guide member 394, 396 may be forced to pivot downwards towards the floor 24 of the vehicle 22 via the interaction between the guiding shaft 420, 422 of each guide member 394, 396 and the respective guiding slot 226, 240. Specifically, as the guiding shafts 420, 422 traverse the respective guiding slot 226, 240, both the first and the second guide member 394, 396 are forced to pivot toward the floor 24 of the vehicle 22 at the second pivot axis 412 and the third pivot axis 418, as a result of the non-linear path defined by the first and second guiding slots 226, 240. Further, the guide members 394, 396 may pivot relative to the inner slide links 434, 434′ of both the first dual-link assembly 428 and the second dual-link assembly 430 about the fourth pivot axis 494 and the fifth pivot axis 498 as the guide members 394, 396 translate towards the end member 101 of the calf rest 36. As the guide members 394, 396 translate towards the end member 101, the dual-link assemblies 428, 430 are expanded, as the inner slide links 434, 434′ and the dual guide links 436, 436′ slide relative to the outer slide links 432, 432′ towards the end member 101. Additionally, as the guide members 394, 396 translate towards the end member 101, the calf rest 36 pivots about the first pivot axis 96, lifting the calf rest 36 away from and upwards relative to the floor 24 of the vehicle 22. As such, the end member 101 of the calf rest 36 begins to slide outwards from the intermediary member 100 and pivot away from the floor 24 of the vehicle 22. Consequently, the calf rest 36 is transitioned from the retracted position R to the intermediate position I.

As shown in FIGS. 2B and 19B, from the intermediate position I, the calf support actuator 366 may continue to exert a force against the actuating element 368. As such, the rear link flange 334, 334′ formed by the slide link 320, 320′ of both the first link assembly 314 and the second link assembly 316 may contact the respective guide link 318, 318′ when the guide link 318, 318′ has been substantially received within the respective sliding track 322, 322′. As such, both the slide links 320, 320′ and the guide links 318, 318′ slide in tandem, relative to the respective slide plate 252, 254 towards the end member 101. Both the slide links 320, 320′ and the guide links 318, 318′ will continue to slide until the front link flange 336, 336′ formed by each slide link 320, 320′ contacts the front stop flange 298, 300 formed by the respective side plate 252, 254. Until the slide links 320, 320′ and the guide links 318, 318′ contact the respective front stop flange 298, 300, the calf rest 36 continues expanding from the intermediary position I, as the guide members 394, 396 drive the inner slide links 434, 434′ causing the end member 101 to slide away from the intermediary member 100, and the intermediary member 100 to slide away from the base member 98. Further, the calf rest 36 continues to pivot away from the floor 24 of the vehicle 22 about the first pivot axis 96 defined by the pivot member 42. The calf rest 36 reaches the extended position E once the driving of the guide members 394, 396 is prevented due to contact between the front stop flanges 298, 300 with the respective slide link 320, 320′ and the respective guide link 318, 318′.

As shown in FIGS. 2C and 19C, from the extended position E, the calf rest 36 may be returned to the retracted position R via the calf support actuator 366 exerting a force on the actuating element 368 to cause the crossbar 370 to translate the slide link 320, 320′ of the first link assembly 314 and second link assembly 316 relative to the respective side plate 252, 254 towards the rear of the vehicle 22. Further, as the slide links 320, 320′ are translated, the guide members 394, 396 are likewise translated toward the rear of the vehicle 22, translating the inner slide link 434, 434′ of both the first dual-link assembly 428 and the second dual-link assembly 430, and causing the end member 101 to begin translating toward the base member 98. As the guide members 394, 396 are translated, each guiding shaft 420, 422 forces the respective guide member 394, 396 to pivot about the second pivot axis 412, the third pivot axis 418, the fourth pivot axis 494, and the fifth pivot axis 498 upwards, towards the ceiling of the vehicle 22, as a result of the non-linear path defined by the respective guiding slot 226, 240. The calf rest 36 may reach the intermediate position I when the front link flanges 336, 336′ formed by each slide link 320, 320′ contacts the respective outer protrusion 362, 362′ formed by the respective guide link 318, 318′.

From the intermediate position I, the calf rest 36 may continue to retract, as the crossbar 370 drives the slide links 320, 320′ and the slide links 320, 320′ subsequently drive the guide links 318, 318′, relative to the side plates 252, 254, as a result of the contact between the front link flanges 336, 336′ and the outer protrusions 362, 362′. As such, the slide links 320, 320′ drive the guide members 394, 396 towards the rear of the vehicle 22, and the guide members 394, 396 continue to cause the translation of the inner slide links 434, 434′, dual guide links 436, 436′, and the end member 101 towards the rear of the vehicle 22. Further, as the slide links 320, 320′ translate, the calf rest 36 pivots downwards at the first pivot axis 96 towards the floor 24 of the vehicle 22. The calf rest 36 reaches the retracted position R when the inner protrusion 364, 364′ of each guide link 318, 318′ contacts the rear stop flange 302, 304 of each side plate 252, 254 and the end member 101 and the intermediary member 100 are each received by the base member 98.

The calf support mechanism 32 of the present disclosure may provide a variety of advantages. First, the calf support mechanism 32 facilitates the lateral movement and vertical movement of the calf rest 36 via the cooperation of the link assesmblies 314, 316, 428, 430, the guide members 394, 396, and the non-linear tracks 226, 240 formed by the connector plate 170. This allows the calf rest 36 to both raise and extend relative to the support bracket 28, providing support for the legs of the user as well as lifting the legs of the user from the floor 24 of the vehicle 22. Further, the use of the expandable trim member 502 and an associated cover, provides a seamless exterior to the calf rest 36. Specifically, the use of the expandable trim member 502 creates a “water-fall” like effect as the expandable trim member 502 and associated cover seamlessly expands in accordance with the expansion of the calf rest 36 from the retracted position R, the intermediate position I, and to the extended position E.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seating assembly, comprising:
a support bracket; and
a calf support mechanism operatively coupled to the support bracket, comprising:
a link assembly operatively coupled with the support bracket;
a dual-link assembly;
a calf rest coupled to the dual-link assembly; and
a guide member, wherein the guide member is coupled to the link assembly and the dual-link assembly to guide the calf rest of the calf support mechanism between a retracted position and an extended position.

2. The vehicle seating assembly of claim 1, wherein the link assembly includes a slide link and a guide link, wherein the slide link is slidably coupled with the guide link.

3. The vehicle seating assembly of claim 1, wherein the dual-link assembly includes a pair of slide links and a dual guide link, wherein the pair of slide links are slidably coupled to opposed sides of the dual guide link.

4. The vehicle seating assembly of claim 2, wherein the slide link is coupled to the guide member.

5. The vehicle seating assembly of claim 3, wherein the pair of slide links comprises:
an outer slide link; and
an inner slide link, wherein the inner slide link is coupled with the calf rest.

6. The vehicle seating assembly of claim 1, wherein the calf rest comprises:
a base member;
an intermediary member, slidably coupled to the base member; and
an end member, slidably coupled to the intermediary member.

7. The vehicle seating assembly of claim 6, wherein the dual-link assembly is coupled to the end member of the calf rest.

8. A vehicle seating assembly, comprising:
a support bracket; and
a calf support mechanism operatively coupled to the support bracket, comprising:
a hinge member;
a calf rest pivotably coupled to the hinge member;
a first link assembly operatively coupled to the support bracket;
a second link assembly operatively coupled to the support bracket;
a first dual-link assembly operatively coupled to the calf rest;
a second dual-link assembly operatively coupled to the calf rest; and
a first guide member, wherein the first guide member is coupled to the first link assembly and the first dual-link assembly to guide the calf rest between a retracted position and an extended position.

9. The vehicle seating assembly of claim 8, further comprising a crossbar extending between the first link assembly and the second link assembly.

10. The vehicle seating assembly of claim 8, further comprising a cross-link extending between the first dual-link assembly and the second dual-link assembly.

11. The vehicle seating assembly of claim 8, further comprising a connector plate extending between the first link assembly and the second link assembly.

12. The vehicle seating assembly of claim 11, wherein the connector plate comprises:
a first overhang positioned adjacent to the first link assembly; and
a second overhang positioned adjacent to the second link assembly.

13. The vehicle seating assembly of claim 12, wherein the connector plate further comprises:
a first guiding slot formed by the first overhang; and
a second guiding slot formed by the second overhang.

14. The vehicle seating assembly of claim 13, wherein the first guide member forms a first guiding shaft slidably coupled with the first guiding slot.

15. The vehicle seating assembly of claim 13, wherein a first length of the first guiding slot is vertically superior relative to a second length of the first guiding slot.

16. A vehicle seating assembly, comprising:
a support bracket; and
a calf support mechanism, operatively coupled to the support bracket and operable between a first position and a second position, comprising:
a hinge member; coupled to the support bracket;
a calf rest, pivotably coupled to the hinge member;
a first link assembly operatively coupled to the support bracket;
a second link assembly operatively coupled to the support bracket;
a first dual-link assembly operatively coupled to the calf rest;
a second dual-link assembly operatively coupled to the calf rest;
a first guide member, wherein the first guide member is pivotably coupled to the first link assembly and the first dual-link assembly to guide the calf rest between a retracted position and an extended position;
a second guide member, wherein the second guide member is pivotably coupled to the second link assembly and the second dual-link assembly to guide the calf rest between the retracted position and the extended position; and
an expandable trim member coupled to the calf rest.

17. The vehicle seating assembly of claim 16, wherein the calf rest comprises:
a base member pivotably coupled to the hinge member;
an intermediary member slidably coupled to the base member; and
an end member slidably coupled to the intermediary member.

18. The vehicle seating assembly of claim 17, wherein the expandable trim member extends between the base member and the end member to substantially cover an exterior surface of the calf rest.

19. The vehicle seating assembly of claim 17, wherein the intermediary member is configured to slide relative to the base member, and the end member is configured to slide relative to the intermediary member as the calf support mechanism transitions between the first position and the second position.

20. The vehicle seating assembly of claim 16, wherein the expandable trim member is configured to elastically expand as the calf support mechanism transitions from the first position to the second position.
